(19) United States
(12) Patent Application Publication
(10) Pub. No.: US 2009/0067855 A1
(43) Pub. Date: Mar. 12, 2009

(54) IMAGE FORMING APPARATUS AND PRINT MEDIUM SENSING METHOD THEREOF

(75) Inventors: Chang-hyeon Shim, Yongin-si (KR); IIak-kyum Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/170,638

(22) Filed: Jul. 10, 2008

(30) Foreign Application Priority Data
Sep. 12, 2007 (KR) 2007-92765

(51) Int. Cl. G03G 15/00

(52) U.S. Cl. 399/21; 399/23

(57) ABSTRACT

An image forming apparatus includes a main body having an image forming unit, a medium feeding unit installed in the main body, having a loading plate to load a print medium thereon and to feed the loaded print medium to the image forming unit, a medium sensing unit which comprises an interference unit which operates to correspond with the print medium loaded on the loading plate and the print medium fed by the medium feeding unit and the print medium being in a registration position on a feeding path, and a sensor having a sensing position and sensing a movement of the interference unit, and a controller to determine whether the print medium is loaded on the loading plate and whether the print medium is in the registration position on the feeding path, based on a sensing signal of the sensor.

### CROSS-REFERENCE TO RELATED APPLICATIONS

This application claims priority from Korean Patent Application No. 10-2007-0092765, filed on Sep. 12, 2007, in the Korean Intellectual Property Office, the disclosure of which is incorporated herein in its entirety by reference.

### BACKGROUND OF THE INVENTION

1. Field of the Invention

The present general inventive concept relates to an image forming apparatus which forms an image on a print medium and a print medium sensing method thereof, and more particularly, to an image forming apparatus which senses whether a print medium is loaded on a loading plate and whether a print medium is in a registration position, and a print medium sensing method thereof.

2. Description of the Related Art

An image forming apparatus includes a medium feeding unit which has a loading plate to load a print medium thereon, and an image forming unit to form a visible image on a print medium with a developer. The print medium is fed from the medium feeding unit to the image forming unit through a plurality of feeding rollers if a printing operation begins.

A sensing unit is provided in the medium feeding unit to sense whether the print medium is loaded on the loading plate to thereby perform the printing operation. The sensing unit is installed in a registration position along a print medium feeding path between the medium feeding unit and the image forming unit. Each sensing unit senses a presence and an absence of the print medium and transmits a sensing result to a controller of the image forming apparatus. Then, the controller performs an operation corresponding to the sensing result. The sensing unit includes an actuator which operates corresponding to the print medium and a sensor which senses the operation of the actuator and outputs a sensing signal.

Each conventional image forming apparatus includes a sensing unit to sense the print medium loaded on the medium feeding unit, and another sensing unit to sense the print medium in the registration position. Therefore, since each sensing unit includes an actuator, a sensor and other elements such as a cable to transmit a signal from the sensor to the controller, an installation configuration becomes complicated and the elements included therein require additional space. In addition, manufacturing costs associated therewith increase.

### SUMMARY OF THE INVENTION

The present general inventive concept provides an image forming apparatus which senses whether a print medium is loaded on a loading plate and whether a print medium is in a registration position through a single sensor, and a print medium sensing method thereof.

Additional aspects and utilities of the present general inventive concept will be set forth in part in the description which follows and, in part, will be obvious from the description, or may be learned by practice of the present general inventive concept.

The foregoing and/or other aspects and utilities of the present general inventive concept may be achieved by providing an image forming apparatus including a main body having an image forming unit, a medium feeding unit installed in the main body, having a loading plate to load a print medium thereon and to feed the loaded print medium to the image forming unit, a medium sensing unit which comprises an interference unit which operates to correspond with the print medium loaded on the loading plate and the print medium fed by the medium feeding unit and being in a registration position on a feeding path, and a sensor having a sensing position and sensing a movement of the interference unit and a controller to determine whether the print medium is loaded on the loading plate and whether the print medium is in the registration position on the feeding path, based on a sensing signal of the sensor.

The interference unit may include a first actuator rotatably installed in the main body or the medium feeding unit centered about a rotation shaft therein and which rotates due to an interference with the print medium loaded on the loading plate, a second actuator which extends toward the registration position from the rotation shaft and rotates due to the interference with the print medium in the registration position, and a sensing actuator which is installed on the rotation shaft and which passes the sensing position while rotating with the first and second actuators.

The first actuator, the second actuator and the sensing actuator may be integrally formed and rotate with respect to the rotation shaft.

The sensing actuator in a reference position may be out of the sensing position, a first end of the sensing actuator in a first position is in the sensing position, and a second end of the sensing actuator in a second position is in the sensing position if it is assumed that the reference position is a rotating position of the sensing actuator when the print medium is not loaded on the loading plate, the first position is a rotating position of the sensing actuator when a single print medium is loaded on the loading plate, and the second position is a rotating position of the sensing actuator when a maximum load amount of print media is loaded on the loading plate.

The loading plate may be formed with a first accommodation hole which accommodates the first actuator therein if the sensing actuator is in the reference position, and the first actuator is accommodated in the first accommodation hole when the print medium is not loaded on the loading plate, and not accommodated in the first accommodation hole when the print medium is loaded on the loading plate and interferes with the first actuator.

The sensing actuator in a third position may be out of the sensing position, and the second actuator and the sensing actuator may return to the reference position or a position between the first and second positions if it is assumed that the third position is the position of the sensing actuator when the print medium interferes with the second actuator in the registration position.

The first, second and third positions may be sequentially arranged from the reference direction in a rotational direction.

The image forming apparatus may further include a guide member being provided on the feeding path and which guides the print medium, wherein the guide member is formed with a second accommodation hole which accommodates the second actuator therein and allows the sensing actuator to rotate from the reference position to the third position.

The controller may determine whether the print medium is loaded on the loading plate and whether the print medium is in the registration position, based on the sensing signal and a time difference between a turn-on and a turn-off of the sensing signal.

The controller may determine that the print medium is loaded on the loading plate if power is initially applied to the image forming apparatus and the sensing signal is turned on, on an assumption that the sensing signal is turned on when the sensing actuator is in the sensing position.

The controller may determine that the print medium passes the registration position if the sensing signal is changed again after a lapse of time T1 from a time when the sensing signal is changed, wherein the time T1 is a time between a time of interference with the second actuator by a front end of the print medium and a time of a rear end of the print medium being out of the second actuator.

The controller may determine that an error occurs if the sensing signal remains changed after the lapse of time T1 from the time when the sensing signal is changed.

The controller may determine that an error occurs if the sensing signal is not changed after a lapse of time T2 from a time when the print medium is fed from the loading plate, wherein the time T2 refers to a time between a time of feeding the print medium from the loading plate and a time of interference of the print medium with the second actuator.

The error may comprise at least one of a jam in which the print medium is not fed, and an absence of the print medium on the medium feeding unit.

The foregoing and/or other aspects and utilities of the present general inventive concept may also be achieved by providing a print medium sensing method of an image forming apparatus, the image forming apparatus including a medium feeding unit having a loading plate to load a print medium thereon and feeding the print medium to perform a printing operation, and a medium sensing unit which has an interference unit operating corresponding to a print medium loaded on the loading plate and a print medium in a registration position on a feeding path, and a sensor which has a sensing position and senses a movement of the interference unit, the method includes determining whether the print medium is loaded on the loading plate based on a sensing signal outputted by the sensor when the printing operation is not performed, and determining the registration position of the print medium based on a change pattern of the sensing signal when the printing operation is performed.

The interference unit may include a first actuator being interfered with by the print medium loaded on the loading plate and which rotates about a rotation shaft thereof, a second actuator being interfered by the print medium in the registration position and which rotates about the rotation shaft, and a sensing actuator which moves with the first and second actuators and passes the sensing position while rotating.

The determining the registration position may include determining that the print medium passes the registration position if the sensing signal is changed again after a lapse of time T1 from a time when the sensing signal is changed, wherein the time T1 is a time between a time of interference with the second actuator by a front end of the print medium and a time of a rear end of the print medium being out of the second actuator.

The determining the registration position may include determining that an error occurs if the sensing signal remains changed after the lapse of time T1 from the time when the sensing signal is changed.

The determining the registration position may include determining that an error occurs if the sensing signal is not changed after a lapse of time T2 from a time when the print medium is fed from the loading plate, wherein the time T2 refers to a time from a time of feeding the print medium from the loading plate to a time of interference by the print medium with the second actuator.

The error may include at least one of a jam in which the print medium is not fed, and an absence of the print medium in the medium feeding unit.

The determining whether the print medium may be loaded on the loading plate may include determining whether the print medium is loaded on the loading plate based on a state of the sensing signal when power is initially applied to the image forming apparatus.

The foregoing and/or other aspects and utilities of the present general inventive concept may also be achieved by providing an image forming apparatus including an image forming unit, a loading plate to load a print medium thereon and to feed the loaded print medium to the image forming unit, a medium sensing unit which senses the loaded print medium at a plurality of positions, and a controller to determine a presence or absence of the print medium at the plurality of positions.

The plurality of positions may include a reference position, a first position, a second position and a third position.

### BRIEF DESCRIPTION OF THE DRAWINGS

The above and/or other aspects and utilities of the present general inventive concept will become apparent and more readily appreciated from the following description of the embodiments, taken in conjunction with the accompanying drawings of which:

FIG. 1 is a lateral sectional view of an image forming apparatus according to an exemplary embodiment of the present general inventive concept;

FIG. 2 is a block diagram of the image forming apparatus in FIG. 1;

FIG. 3 is a perspective view of a medium sensing unit of the image forming apparatus in FIG. 1;

FIG. 4 is a lateral sectional view of a sensing actuator which is in a reference position in the medium sensing unit in FIG. 3;

FIG. 5 is a lateral sectional view of the sensing actuator which is in a first position in the medium sensing unit in FIG. 3;

FIG. 6 is a lateral sectional view of the sensing actuator which is in a second position in the medium sensing unit in FIG. 3;

FIG. 7 is a lateral sectional view of the sensing actuator which is in a third position in the medium sensing unit in FIG. 3; and

FIG. 8 is a flowchart illustrating a method of sensing a print medium loaded on a loading plate and in a registration position.

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to like elements throughout and repetitive descriptions will be avoided as necessary. The exemplary embodiments are described below in order to explain the present general inventive concept by referring to the figures.

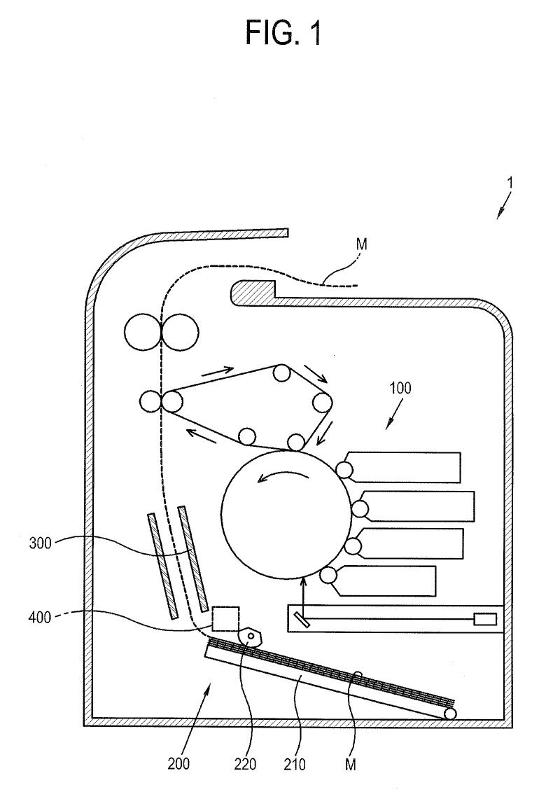

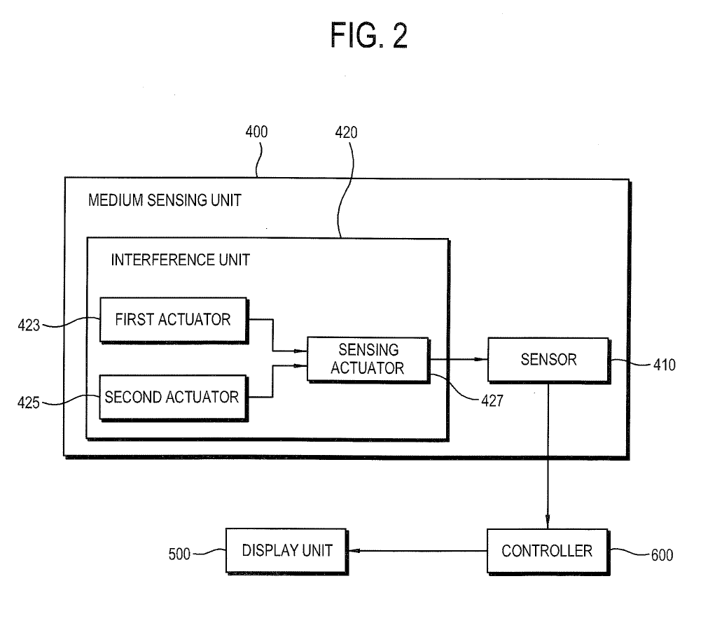

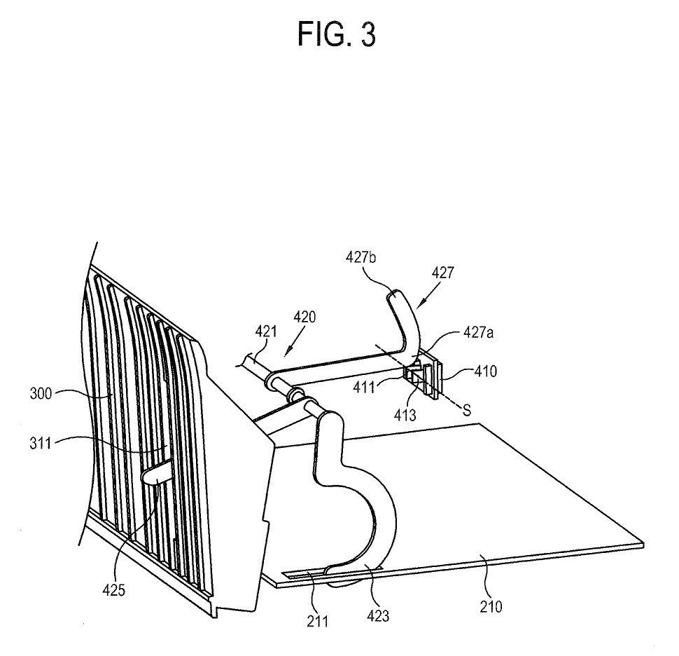

FIG. 1 is a lateral sectional view of an image forming apparatus according to an exemplary embodiment of the present general inventive concept. FIG. 2 is a block diagram of the image forming apparatus. FIG. 3 is a perspective view of a medium sensing unit of the image forming apparatus.

As shown in FIGS. 1 through 3, an image forming apparatus 1 according to the exemplary embodiment of the present general inventive concept includes a main body (not shown) which has an image forming unit 100 which forms a visible image on a print medium M with a developer, a medium feeding unit 200 which has a loading plate 210 to load the print medium M thereon and feeds the print medium M to the image forming unit 100, a medium sensing unit 400 which senses the print medium M loaded on the loading plate 210 and the print medium M which passes a registration position and the medium sensing unit 400 outputs a sensing signal, and a controller 600 which determines whether or not the print medium M is loaded on the loading plate 210 and whether or not the print medium M is in the registration position of a feeding path, based on the sensing signal.

The registration position refers to a position which is placed along the feeding path of the print medium M between the medium feeding unit 200 and the image forming unit 100. As the controller 600 determines whether the print medium M passes the registration position, it controls various operations. For example, the controller 600 determines whether or not the print medium M is fed to the image forming unit 100, or whether or not a print medium M jam occurs. In an exemplary embodiment, the controller 600 may determine a feeding speed of the print medium M which is fed by the medium feeding unit 200 and may adjust the feeding speed of the print medium M according to a preset timing.

The image forming apparatus 1 may further include a display unit 500 to display a predetermined control operation of the controller 600. The display unit 500 displays errors such as an absence of the print medium M on the loading plate 210 or a print medium M jam.

The image forming apparatus 1 further includes a guide member 300 which is provided between the medium feeding unit 200 and the image forming unit 100 to guide the print medium M. In the current exemplary embodiment, the registration position is formed within the guide member 300, however the present general inventive concept is not limited thereto.

At least one feeding roller (not shown) may be provided between the medium feeding unit 200 and the image forming unit 100 to feed the print medium M. However, the means for feeding the print medium M is not limited thereto. For example, a feeding belt (not shown) may be provided to feed the print medium M.

The medium feeding unit 200 stores the print medium M therein, and feeds the print medium M to the image forming unit 100 if a printing operation begins. The medium feeding unit 200 includes the loading plate 210 which is provided to load the print medium M on a plate surface thereof, and a pickup roller 220 to pick up the print medium M loaded on the loading plate 210.

The loading plate 210 is shaped like a plate and the print medium M is loaded thereon. However, the present general inventive concept is not limited thereto. That is, the loading plate 210 may include various other shapes and configurations in order to accommodate the print medium M. A first accommodation hole 211 is depressedly or penetratedly formed on the loading plate 210. The first accommodation hole 211 may accommodate an end part of a first actuator 423 (to be described later) when the print medium M is not loaded on the loading plate 210. However, when at least one print medium M is loaded on the loading plate 210, the first accommodation hole 211 is covered with the print medium M. Then, the relationship between the first actuator 423 and the first accommodation hole 211 is interfered with by the print medium M and the first actuator 423 is thereby not accommodated in the first accommodation hole 211.

The guide member 300 guides the print medium M picked up by the pickup roller 220 to the image forming unit 100. The guide member 300 extends in a direction along the feeding path of the print medium M.

A second accommodation hole 311 is penetratedly formed in a part of the registration position in the guide member 300. The second accommodation hole 311 is formed to accommodate a second actuator 425 (to be described later). The second accommodation hole 311 extends in a direction along the feeding path of the print medium M so as to not interfere with a rotation of the second actuator 425.

If the registration position is disposed within the part of the guide member 300 as in the current exemplary embodiment of the present general inventive concept, the second accommodation hole 311 of the guide member 300 is formed in a position so as to not interfere with the rotation of the second actuator 425. If the registration position is not disposed within the part of the guide member 300, the guide member 300 does not affect the rotation of the second actuator 425. In this case, the second accommodation hole 311 may be omitted.

The medium sensing unit 400 senses the print medium M loaded on the loading plate 210 and the print medium M in the registration position, and outputs a sensing signal. The medium sensing unit 400 includes an interference unit 420 which operates corresponding to the print medium M loaded on the loading plate 210 and the print medium M in the registration position, and a sensor 410 which has a sensing position S on a moving path of the interference unit 420, senses the movement of the interference unit 420 and outputs a sensing signal.

The sensor 410 senses a part of the interference unit 420, and more specifically, a part of a sensing actuator 427 (to be described later) in the sensing position S and transmits a sensing signal to the controller 600. The sensor 410 preferably includes a photo sensor, but the present general inventive concept is not limited thereto.

The sensor 410 includes a light emitter 411 to generate and emit light, and a light receiver 413 to receive the light from the light emitter 411. The sensing position S is on an optical path where the light is emitted from the light emitter 411 toward the light receiver 413. If a part of the sensing actuator 427 is disposed in the sensing position S, the optical path between the light emitter 411 and the light receiver 413 is cut off. For example, when the light emitted to the light receiver 413 is cut off, the sensor 410 outputs a signal. However, the present general inventive concept is not limited thereto.

The sensor 410 according to the current exemplary embodiment of the present general inventive concept turns on a signal when the part of the sensing actuator 427 is disposed in the sensing position S, and turns off a signal when the part of the sensing actuator 427 is not in the sensing position S, however the present general inventive concept is not limited thereto. Alternatively, the sensor 410 may turn off a signal when the part of the sensing actuator 427 is disposed in the sensing position S and may turn on a signal when the part of the sensing actuator 427 is not in the sensing position S.

The interference unit 420 rotates with respect to a rotation shaft 421 which extends from the main body or a lateral side of the medium feeding unit 200. The interference unit 420 includes the first actuator 423, the second actuator 425 and the sensing actuator 427 which are each rotatably connected with the rotation shaft 421. In an exemplary embodiment, the first actuator 423, the second actuator 425 and the sensing actuator 427 are integrally formed and rotate with respect to the rotation shaft 421. That is, if one of the first actuator 423, the second actuator 425, and the sensing actuator 427 rotates, the remaining two elements also rotate.

After rotating due to the interference with the print medium M, the first actuator 423, the second actuator 425 and the sensing actuator 427 return to original positions thereof when the print medium M stops interfering therewith. For example, the first actuator 423, the second actuator 425, and the sensing actuator 427 return to the original positions by their own weight or by a force such as a spring (not shown) of the rotation shaft 421. However, the present general inventive concept is not limited thereto. That is, the first actuator 423, the second actuator 425, and the sensing actuator 427 may return to their original positions, respectively, by a force other than a spring force.

The first actuator 423 extends toward the loading plate 210 from the rotation shaft 421, and rotates due to an interference with the print medium M loaded on the loading plate 210. If the print medium M is not loaded on the loading plate 210, a first end part of the first actuator 423 is accommodated in the first accommodation hole 211. Meanwhile, if at least one print medium M is loaded on the loading plate 210, the first end part of the first actuator 423 is interfered with the print medium M and is thereby not accommodated within the first accommodation hole 211.

The first actuator 423 is stably seated or disposed on a top print medium M of print media M, i.e. on a print medium M that is picked up by the pickup roller 220 at a subsequent printing operation as the amount of the print media M increases.

The second actuator 425 extends toward the registration position from the rotation shaft 421, and passes into the second accommodation hole 311. If a front end of the print medium M which is guided by the guide member 300 reaches the registration position and interferes with a first end part of the second actuator 425, the second actuator 425 rotates along the second accommodation hole 311. While the print medium M moves and interferes with the second actuator 425, the second actuator 425 continues to rotate. If a rear end of the print medium M is out of the registration position and stops interfering with the second actuator 425, the second actuator 425 returns to its original position.

The sensing actuator 427 rotates together with the rotation of the first and second actuators 423 and 425. That is, the rotation of the sensing actuator 427 corresponds with the rotation of the first and second actuators 423 and 425. The sensing actuator 427 extends in a radial direction with respect to the rotation shaft 421, and is bent with respect to a surface of the sensing actuator 427. The bent sensing actuator 427 extends along a circular arc that passes through the sensing position S, which is centered with respect to the rotation shaft 421. A length of the upper and lower ends 427b and 427a of the sensing actuator 427 extends along the circular arc and corresponds to a difference between a thickness of a single sheet of print medium M and a thickness of a maximum load amount of the print media M loaded on the loading plate 210. The relation between the length of the upper and lower ends 427b and 427a and the thickness of the print medium M will be described later.

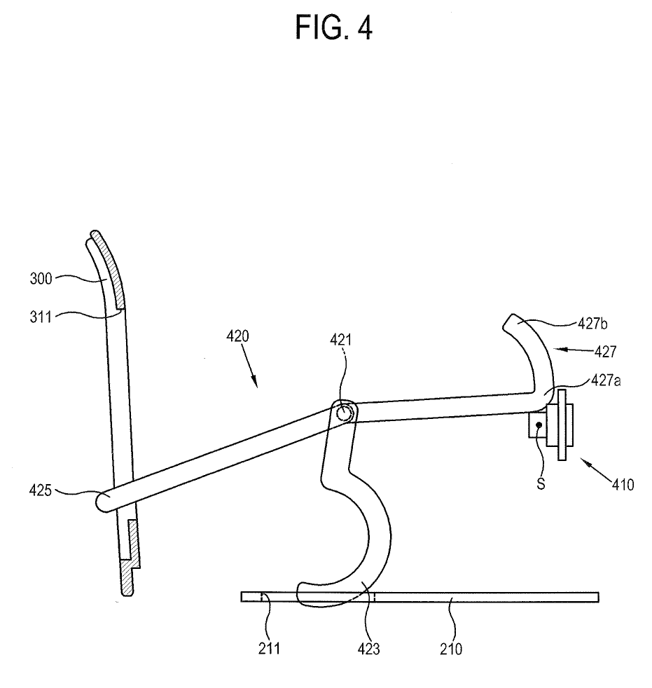

Hereinafter, operations of each element of the medium sensing unit 400 will be described with reference to FIGS. 4 to 7.

FIGS. 4 to 7 are lateral sectional views of the sensing actuator 427 according to the rotating positions. FIGS. 4 to 7 illustrate a rotation of the first actuator 423, the second actuator 425 and the sensing actuator 427, which are centered with respect to the rotation shaft 421. The positions and rotation directions of the first actuator 423, the second actuator 425 and the sensing actuator 427 exemplify the present general inventive concept, and therefore do not limit the present general inventive concept thereto.

The first and second actuators 423 and 425 rotate clockwise due to the interference with the print medium M. First, second and third positions are sequentially arranged clockwise, based on the reference position. However, the present general inventive concept is not limited thereto. That is, in exemplary embodiments, the first, second and third positions may be sequentially arranged counter-clockwise with respect to the reference position.

FIG. 4 illustrates the sensing actuator 427 in a reference position. As shown therein, the reference position is a rotating position of the sensing actuator 427 when the print medium M is not loaded on the loading plate 210. In this case, the first actuator 423 is accommodated in the first accommodation hole 211 while the second actuator 425 is in the registration position. The sensing actuator 427 which is in the reference position rotates counter-clockwise from the sensing position S of the sensing unit 410, i.e. is upwardly positioned. That is, the lower end 427a of the sensing actuator 427 is disposed above the sensing position S.

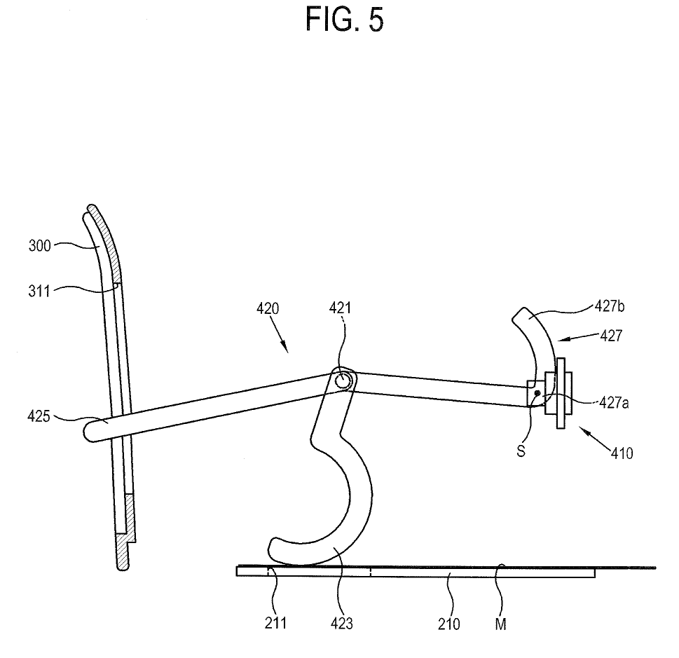

FIG. 5 illustrates the sensing actuator 427 in a first position. As shown therein, the first position is a rotating position of the sensing actuator 427 when a single print medium M is loaded on the loading plate 210. In this case, the first actuator 423 is out of the first accommodation hole 211 and is stably seated or disposed on the print medium M. The second actuator 425 rotates clockwise in a first angle from the registration position. The lower end 427a of the sensing actuator 427 is disposed in the sensing position S.

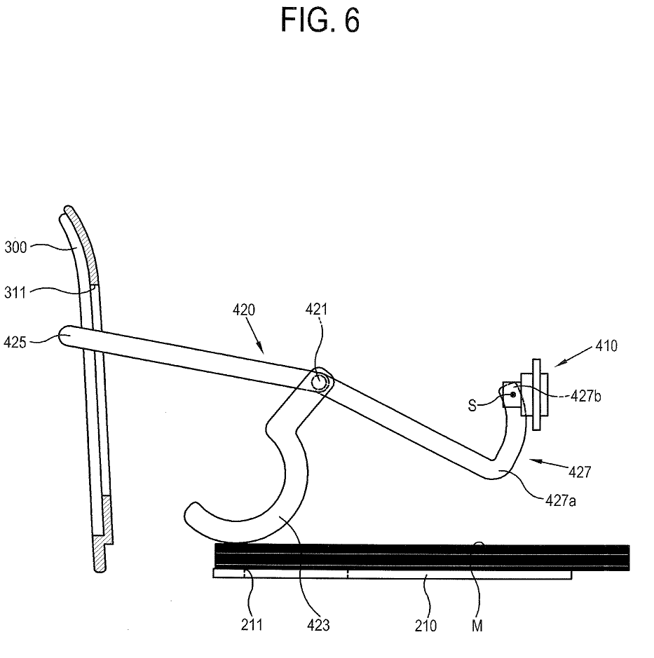

FIG. 6 illustrates the sensing actuator 427 in a second position. As shown therein, the second position is a rotating position of the sensing actuator 427 when the maximum load amount of the print media M is loaded on the loading plate 210. In this case, the first actuator 423 is stably seated or disposed on a top print medium M of the print media M loaded on the loading plate 210. The second actuator 425 rotates clockwise in a second angle. The upper end 427b of the sensing actuator 427 is disposed in the sensing position S. In exemplary embodiments, the first and/or second angle is predetermined and the second angle is larger than the first angle. However, the present general inventive concept is not limited thereto.

If the total amount of the print media M loaded on the loading plate 210 ranges between a single sheet of print medium M and the maximum load amount, the rotating position of the first actuator 423 is disposed between the first and second positions of the sensing actuator 427. A part of the sensing actuator 427, i.e. a part of the lower end 427a and the upper part 427b is disposed in the sensing position S. Thus, the extension of the lower end 427a and upper end 427b of the sensing actuator 427 corresponds to the difference between the thickness of a single print medium M and the thickness of the maximum load amount of the print media M loaded on the loading plate 210.

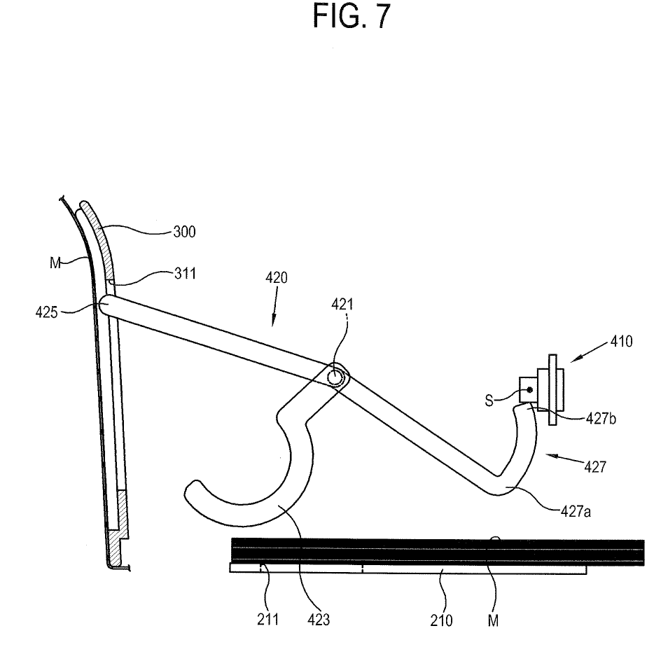

FIG. 7 illustrates the sensing actuator 427 in a third position. As shown therein, the third position is a rotating position of the sensing actuator 427 when the print medium M in the registration position interferes with the second actuator 425. When the print medium M passes the registration position, the second actuator 425 is rotated clockwise by the print medium M. Then, the sensing actuator 427, in turn, rotates clockwise from the sensing position, i.e. rotates downwardly. The upper end 427b of the sensing actuator 427 is disposed below the sensing position S.

If the print medium M is completely out of the registration position and does not interfere with the second actuator 425, the second actuator 425 and the sensing actuator 427 return to the reference position or return to a position between the first and second positions.

Hereinafter, the rotating position of the sensing actuator 427 will be described in detail with reference to FIGS. 4 to 7.

For example, it is assumed that a predetermined amount of print media M is loaded on the loading plate 210 and the length of the print media M is longer than the distance between the first actuator 423 and the second actuator 425. The first actuator 423 is stably seated or disposed on the top print medium M of the loaded print media M. A part of the lower end 427a and the upper end 427b of the sensing actuator 427 is disposed in the sensing position S. If a single print medium M is fed and interferes with the second actuator 425 in the registration position, the sensing actuator 427 rotates to the third position.

If the print medium M stops interfering with the second actuator 425, the first actuator 423, the second actuator 425 and the sensing actuator 427 rotate counterclockwise until the first actuator 423 is interfered with by the print medium M on the loading plate 210. The total amount of the print media M loaded on the loading plate 210 is the amount of print media M excluding a single print medium M from the original amount. The returning position of the sensing actuator 427 in the third position corresponds to the position where the first actuator 423 is interfered by the print media M excluding a single print medium M from the original amount and loaded on the loading plate 210.

If the original amount of the print media M on the loading plate 210 is a single sheet of print medium M, the loading plate 210 does not have a print medium M after the loaded print medium M is fed. In this case, the sensing actuator 427 returns to the reference position from the third position.

Hereinafter, it is assumed that the length of the print media M is shorter than the distance between the first actuator 423 and the second actuator 425 along the feeding path. In this case, when a rear end of the print medium M is out of the first actuator 423, a front end of the print medium M does not reach the registration position. As the rear end of the print medium M is out of the first actuator 423, the first actuator 423 is stably seated or disposed on the print media M excluding a single sheet of print medium M from the original amount. Then, the sensing actuator 427 rotates.

If the fed print medium M stops interfering with the second actuator 425, the sensing actuator 427 returns to an original position.

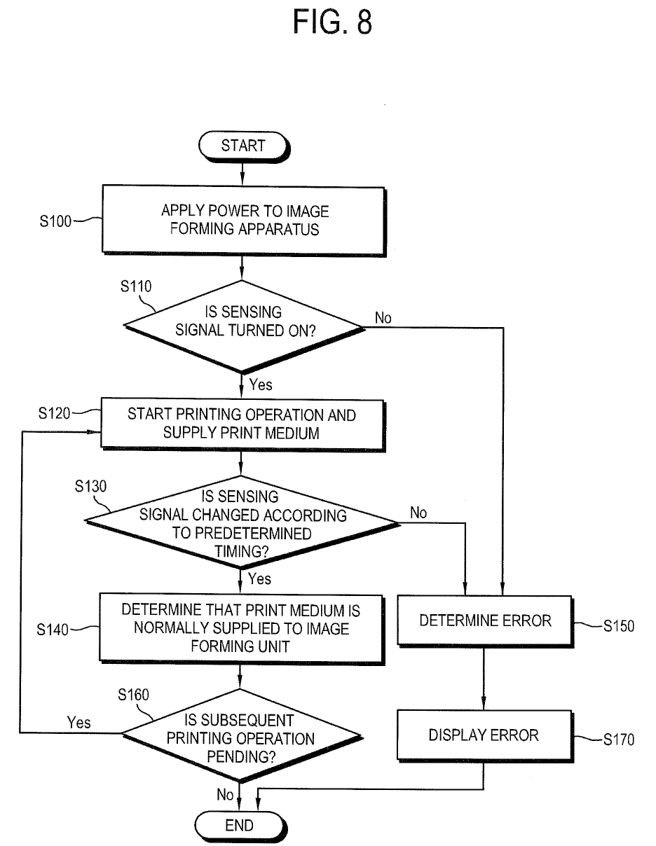

As shown in FIGS. 1 to 3 and 8, the controller 600 determines whether or not the print medium M is loaded on the loading plate 210 and whether or not the print medium M is in the registration position based on the sensing signal and time change. That is, the time change is a time difference between a turn-on and turn-off of the sensing signal.

As described above, the sensing signal is turned-on when the part of the sensing actuator 427 is in the sensing position S. If power is initially applied to the image forming apparatus 1 (S100) and if the sensing signal remains turned-on, the controller 600 determines that the print medium M is loaded on the loading plate 210. Meanwhile, if the sensing signal remains turned-off, the controller 600 determines that an error occurs (S150). Then, the controller 600 determines that the error occurs since the print medium M is not loaded on the loading plate 210.

When power is initially applied to the image forming apparatus 1, the print medium M in the registration position does not interfere with the second actuator 425. The print medium M interferes with the second actuator 425 only after the print medium M is fed from the loading plate 210. The controller 600 determines that the sensing signal is turned on/off by the first actuator 423, and then determines whether or not the print medium M is loaded on the loading plate 210 based on the sensing signal. The controller 600 controls the display unit 500 to display the error thereon to thereby inform a user of the error (S170).

The controller 600 determines the rotating position of the sensing actuator 427 based on on-off states of the sensing signal.

When the sensing actuator 427 is in the reference position, it rotates upwardly from the sensing position S. Thus, the sensing signal is turned off (refer to FIG. 4). The print medium M is neither fed nor passes the registration position. Thus, the controller 600 determines that the print medium M is not loaded on the loading plate 210.

When the sensing actuator 427 is in the first position, a single print medium M is loaded on the loading plate 210. The lower end 427a of the sensing actuator 427 is in the sensing position S (refer to FIG. 5). Then, the sensing signal is turned-on and the controller 600 determines that the print medium M is loaded on the loading plate 210.

When the sensing actuator 427 is in the second position, the maximum load amount of the print media M is loaded on the loading plate 210. The upper end 427b of the sensing actuator 427 is in the sensing position S (refer to FIG. 6). Then, the sensing signal is turned-on, and the controller 600 determines that the print medium M is loaded on the loading plate 210.

When a predetermined amount of print media M is loaded on the loading plate 210, a part of the lower and upper ends 427a and 427b of the sensing actuator 427 is in the sensing position S. The predetermined amount ranges between a single print medium M and the maximum load amount of print media M. Then, the sensing signal is turned-on, and the controller 600 determines that the print medium M is loaded on the loading plate 210.

If the printing operation is not performed, only the rotation of the first actuator 423 is considered. The sensing signal is turned on as the print medium M interferes with the first actuator 423. Then, the controller 60 determines that the print medium M is loaded on the loading plate 210. Meanwhile, the sensing signal is turned off if the print medium M does not interfere with the first actuator 423. Then, the control 600 determines that the print medium M is not loaded on the loading plate 210.

If power is initially applied to the image forming apparatus 1 and if the sensing signal is turned on, the controller 600 determines that the print medium M is loaded on the loading plate 210. If the printing operation begins, the controller 600 feeds a single sheet of print medium M from the loading plate 210 (S120). Then, the controller 600 determines whether or not the sensing signal is alternately turned on and off according to a predetermined time (to be described later) (S130).

If a single print medium M is fed from the loading plate 210 and interferes with the second actuator 425 in the registration position, the sensing actuator 427 rotates to the third position (refer to FIG. 7). Then, the sensing signal is turned-off. If the rear end of the print medium M is out of the second actuator 425 and does not interfere with the second actuator 425, the sensing actuator 427 returns to the sensing position S. Then, the sensing signal is turned-on again.

If the sensing signal is turned on a time T1 after being turned off, the controller 600 determines that the print medium M passes the registration position and is normally fed to the image forming unit 100 (S140). The time T1 refers to a time between a time of interfering with the second actuator 425 by the front end of the print medium M to a time of stopping an interference with the second actuator 425 by the rear end of the print medium M. That is, the time T1 refers to a time during which the print medium M interferes with the second actuator 425.

If it is determined that the print medium M is normally fed to the image forming unit 100, the controller 600 determines whether or not a subsequent printing operation is pending (S160). If the subsequent printing operation is pending, the controller 600 feeds another sheet of the print medium M from the loading plate 210.

However, a print medium M jam may occur if the fed print medium M is not moved smoothly and/or stops moving. Hereinafter, an error such as a print medium M jam will be described.

If the sensing signal remains turned off at the time T1 after being turned off, the controller 600 determines that an error occurs (S150).

That is, the print medium M is not out of the second actuator 425 and is suspended after interfering with the second actuator 425. As the sensing actuator 427 is below the sensing position S, the sensing signal remains turned off. The controller 600 controls the display unit 500 to display the error thereon (S170).

If the sensing signal remains turned on a time T2 after being turned on, the controller 600 determines that an error occurs (S150). The time of detecting a single print medium M fed from the loading plate 210 may vary. For example, the time of driving the pickup roller 220 and picking up the print medium M may be detected. However, the present general inventive concept is not limited thereto.

The time T2 is a time between a time of feeding the print medium M from the loading plate 210 and a time of interference with the second actuator 425 by the print medium M. The error occurs as the print medium M is not out of the first actuator 423 before interfering with the second actuator 425. As the sensing actuator 427 is in the same position as that before the print medium M is fed, the sensing signal remains turned on.

Hereinafter, it is assumed that a single print medium M is loaded on the loading plate 210. The length of the print medium M may be shorter or longer than the distance between the first actuator 423 and the second actuator 425 along the feeding path.

It is assumed that the length of the print medium M is shorter than the distance between the first actuator 423 and the second actuator 425 along the feeding path. The sensing actuator 427 is in the first position and the sensing signal is turned on. The controller 600 determines that the print medium M is loaded on the loading plate 210.

If the printing operation begins, the rear end of the print medium M is out of the first actuator 423. As the front end of the print medium M does not interfere with the second actuator 425, the sensing actuator 427 rotates to the reference position.

If the print medium M is fed and interferes with the second actuator 425, the sensing actuator 427 rotates to the third position. If the print medium M is out of the second actuator 425, the sensing actuator 427 rotates to the reference position.

When the sensing actuator 427 rotates from the third position to the reference position, the sensing actuator 427 passes the sensing position S without any interference. That is, the sensing signal is turned on and then turned off momentarily. If the controller 600 detects the change of the sensing signal while the sensing actuator 427 rotates from the third position to the reference position, the controller 600 determines that the print medium M is not loaded on the loading plate 210.

It is assumed that the length of the print medium M is longer than the distance between the first actuator 423 and the second actuator 425. The sensing actuator 427 is in the first position.

If the printing operation begins, the front end of the print medium M interferes with the second actuator 42 and the rear end thereof is not out of the first actuator 423. The sensing actuator 427 rotates to the third position. Even if the rear end of the print medium M is out of the first actuator 423, the sensing actuator 427 remains in the third position.

If the rear end of the print medium M is out of the second actuator 425, the sensing actuator 427 rotates to the reference position. Then, the sensing actuator 427 passes the sensing position S without any interference. The sensing signal is turned on and then turned off momentarily. If the controller 600 detects the change of the sensing signal, the controller 600 determines that the print medium M is not loaded on the loading plate 210.

As described above, the operations of the first and second actuators 423 and 425 and the sensing actuator 427 differ depending on the length of the print medium M. However, in both cases, the sensing signal is turned on and turned off momentarily as the sensing actuator 427 passes the sensing position S, without any interference, while rotating from the third position to the reference position. The controller 600 detects the change of the sensing signal and determines that the print medium M is not loaded on the loading plate 210.

As described above, the image forming apparatus 1 according to the exemplary embodiment of the present general inventive concept includes the first and second actuators 423 and 425, and the sensing actuator 427, which rotates with the first and second actuators 423 and 425. The sensing unit 410 senses the rotation of the sensing actuator 427 and transmits the sensing signal to the controller 600. The controller 600 may determine whether or not the print medium M is loaded on the loading plate 210 and whether or not the print medium M is in the registration position, based on the sensing signal and the time difference between the turn on and off of the sensing signal.

As described above, the present general inventive concept provides an image forming apparatus which senses whether or not a print medium is loaded on a loading plate and whether or not a print medium is in a registration position through a single sensor, and simplifies a configuration to take a minimal amount of space and reduces manufacturing costs thereof, and a print medium sensing method thereof.

A load to a system including the image forming apparatus due to signal processing may be lowered since only a signal which is outputted by the single sensor is processed. Thus, the image forming apparatus may operate more stably and a reliability thereof may be enhanced.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the present general inventive concept, the scope of which is defined in the appended claims and their equivalents.

What is claimed is:

1. An image forming apparatus, comprising:
a main body having an image forming unit;
a medium feeding unit installed in the main body, having a loading plate to load a print medium thereon and to feed the loaded print medium to the image forming unit;
a medium sensing unit which comprises an interference unit which operates to correspond with the print medium loaded on the loading plate and the print medium fed by the medium feeding unit and the print medium being in a registration position on a feeding path, and a sensor having a sensing position and sensing a movement of the interference unit; and
a controller to determine whether the print medium is loaded on the loading plate and whether the print medium is in the registration position on the feeding path, based on a sensing signal of the sensor.

2. The image forming apparatus according to claim 1, wherein the interference unit comprises a first actuator rotatably installed in the main body or the medium feeding unit centered about a rotation shaft therein and which rotates due to an interference with the print medium loaded on the loading plate;
a second actuator which extends toward the registration position from the rotation shaft and rotates due to the interference with the print medium in the registration position; and
a sensing actuator which is installed on the rotation shaft and which passes the sensing position while rotating with the first and second actuators.

3. The image forming apparatus according to claim 2, wherein the first actuator, the second actuator and the sensing actuator are integrally formed and rotate with respect to the rotation shaft.

4. The image forming apparatus according to claim 2, wherein the sensing actuator in a reference position is out of the sensing position,
a first end of the sensing actuator in a first position is in the sensing position, and
a second end of the sensing actuator in a second position is in the sensing position if it is assumed that the reference position is a rotating position of the sensing actuator when the print medium is not loaded on the loading plate, the first position is a rotating position of the sensing actuator when a single sheet of print medium is loaded on the loading plate, and the second position is a rotating position of the sensing actuator when a maximum load amount of print media is loaded on the loading plate.

5. The image forming apparatus according to claim 4, wherein the loading plate is formed with a first accommodation hole which accommodates the first actuator therein if the sensing actuator is in the reference position; and
the first actuator is accommodated in the first accommodation hole when the print medium is not loaded on the loading plate, and not accommodated in the first accommodation hole when the print medium is loaded on the loading plate and interferes with the first actuator.

6. The image forming apparatus according to claim 4, wherein the sensing actuator in a third position is out of the sensing position, and
the second actuator and the sensing actuator return to the reference position or a position between the first and second positions if it is assumed that the third position is the position of the sensing actuator when the print medium interferes with the second actuator in the registration position.

7. The image forming apparatus according to claim 6, wherein the first, second and third positions are sequentially arranged from the reference direction in a rotational direction.

8. The image forming apparatus according to claim 6, further comprising a guide member being provided on the feeding path and which guides the print medium, wherein
the guide member is formed with a second accommodation hole which accommodates the second actuator therein and allows the sensing actuator to rotate from the reference position to the third position.

9. The image forming apparatus according to claim 2, wherein the controller determines whether the print medium is loaded on the loading plate and whether the print medium is in the registration position, based on the sensing signal and a time difference between a turn-on and a turn-off of the sensing signal.

10. The image forming apparatus according to claim 9, wherein the controller determines that the print medium is loaded on the loading plate if power is initially applied to the image forming apparatus and the sensing signal is turned-on, on an assumption that the sensing signal is turned-on when the sensing actuator is in the sensing position.

11. The image forming apparatus according to claim 9, wherein the controller determines that the print medium passes the registration position if the sensing signal is changed again after a lapse of time T1 from a time when the sensing signal is changed, wherein the time T1 is a time between a time of interference with the second actuator by a front end of the print medium and a time of a rear end of the print medium being out of the second actuator.

12. The image forming apparatus according to claim 11, wherein the controller determines that an error occurs if the sensing signal remains changed after the lapse of time T1 from the time when the sensing signal is changed.

13. The image forming apparatus according to claim 12, wherein the controller determines that an error occurs if the sensing signal is not changed after a lapse of time T2 from a time when the print medium is fed from the loading plate,
wherein the time T2 refers to a time between a time of feeding the print medium from the loading plate and a time of interference of the print medium with the second actuator.

14. The image forming apparatus according to claim 13, wherein the error comprises at least one of a jam in which the print medium is not fed, and an absence of the print medium on the medium feeding unit.

15. A print medium sensing method of an image forming apparatus, the image forming apparatus comprising a medium feeding unit having a loading plate to load a print medium thereon and feeding the print medium to perform a printing operation and a medium sensing unit which has an interference unit operating corresponding to a print medium loaded on the loading plate and a print medium in a registration position on a feeding path, and a sensor which has a sensing position and senses a movement of the interference unit, the method comprising:
determining whether the print medium is loaded on the loading plate based on a sensing signal outputted by the sensor when the printing operation is not performed; and
determining the registration position of the print medium based on a change pattern of the sensing signal when the printing operation is performed.

16. The method according to claim 15, wherein the interference unit comprises a first actuator being interfered with by the print medium loaded on the loading plate and which rotates about a rotation shaft thereof;
a second actuator being interfered by the print medium in the registration position and which rotates about the rotation shaft; and
a sensing actuator which moves with the first and second actuators and passes the sensing position while rotating.

17. The method according to claim 16, wherein the determining the registration position comprises determining that the print medium passes the registration position if the sensing signal is changed again after a lapse of time T1 from a time when the sensing signal is changed,
wherein the time T1 is a time between a time of interference with the second actuator by a front end of the print medium and a time of a rear end of the print medium being out of the second actuator.

18. The method according to claim 17, wherein the determining the registration position comprises determining that an error occurs if the sensing signal remains changed after the lapse of time T1 from the time when the sensing signal is changed.

19. The method according to claim 16, wherein the determining the registration position comprises determining that an error occurs if the sensing signal is not changed after a lapse of time T2 from a time when the print medium is fed from the loading plate,
wherein the time T2 refers to a time from a time of feeding the print medium from the loading plate to a time of interference by the print medium with the second actuator.

20. The method according to claim 19, wherein the error comprises at least one of a jam in which the print medium is not fed, and an absence of the print medium in the medium feeding unit.

21. The method according to claim 15, wherein the determining whether the print medium is loaded on the loading plate comprises determining whether the print medium is loaded on the loading plate based on a state of the sensing signal when power is initially applied to the image forming apparatus.

22. An image forming apparatus, comprising:
an image forming unit;
a loading plate to load a print medium thereon and to feed the loaded print medium to the image forming unit;
a medium sensing unit which senses the loaded print medium at a plurality of positions; and
a controller to determine a presence or absence of the print medium at the plurality of positions.

23. The image forming apparatus according to claim 22, wherein the plurality of positions include a reference position, a first position, a second position and a third position.
